(19) United States
(12) Patent Application Publication
(10) Pub. No.: US 2003/0070304 A1
(43) Pub. Date: Apr. 17, 2003

(54) Cutting foil for rotary shavers and manufacturing methods for producing same

(76) Inventor: Zachary Curello, Cheshire, CT (US)

Correspondence Address: Melvin I. Stoltz, Esq., 51 Cherry Street, Milford, CT, 06460, US

(21) Appl. No.: 10/267,400

(22) Filed: Oct. 8, 2002

Related U.S. Application Data
(60) Provisional application No. 60/329,018, filed on Oct. 15, 2001.

(51) Int. Cl. B26B 19/14

(52) U.S. Cl. 30/346.51; 76/116; 30/346.61; 76/104.1

(57) ABSTRACT

In accordance with the present invention, a plurality of circular shaped, slotted foils or cutting heads are simultaneously produced using electroforming production techniques followed by passage of each slotted foil or cutting head through either a single die or a progressive die to form the slotted foil or cutting head into the desired three-dimensional circular or annular shape required for a rotary shaver. Furthermore, in order to produce a slotted foil or cutting head which is extremely thin, to attain a close, comfortable shave, each of the fully formed slotted foils or cutting heads is passed through an insert molding operation, wherein a supporting rim or ring is affixed to the outer edge of the slotted foil or cutting head, thereby imparting rigidity or stiffness thereto. As a result, slotted foils or cutting head are able to be manufactured at a substantially reduced cost, and with precisely desired and controlled configurations.

### TECHNICAL FIELD

This invention relates to electric dry shavers and more particularly to improved manufacturing methods for producing cutting foils or heads for rotary shavers.

### BACKGROUND ART

Over the last several years, both men and women have been increasingly drawn to the advantages provides by electric dry shavers. In general, the consuming public has found that the use of razors or other systems is extremely inconvenient for removing or shaving short hair or stubble, as commonly found in men's beards and on women's legs. In addition, with the ever-increasing time constraints and commitments individuals typically encounter, a fast and effective shaving system is most desirable.

The discomfort, as well as the time consumed in using shaving cream, soaps, or gels in order to provide a medium for which a razor can be used, requires more time and inconvenience than most individuals are willing or capable of allowing. Furthermore, the cost of maintaining a sufficient supply of these products creates an additional burden. Consequently, electric dry shavers have become increasingly popular, as well as battery-operated electric dry shavers which can withstand exposure to moisture, thereby enabling individuals to simultaneously shower, as well as shave either beards or legs.

As the popularity of electric dry shaves increased, various product designs and alternate constructions proliferated, in an attempt to improve and enhance the comfort and cutting efficiency of such shavers. However, in spite of these product changes, difficulties have continued to exist in providing optimum results with optimum comfort.

Two principal configurations have been found to be extremely efficacious in achieving high quality shaving results, as well as being extremely comfortable to use. These configurations comprise the various models of electric dry shavers incorporating a movable cutting blade which cooperates with a thin, flexible mesh screen or apertured foil and electric dry shavers employing a plurality of rotating circular cutting blades, each associated with a separate, circular shaped foil or slotted cutting head.

In operation, the cutting blades rapidly and continuously move against one side of the apertured foil or slotted cutting head, causing the cutting blades to repeatedly cross the plurality of apertures or slots and provide a virtually continuous cutting action at each aperture or slot. Then, by sliding or guiding the other side of the apertured foil or slotting cutting head over the skin surface to be shaven, the individual hair shafts enter the holes or slots formed in the foil and are cut by the movement of the cutting blades.

Although these dry shaving cutting systems have proven to be extremely effective, as compared to other dry shaving products, one area of difficulty does exist which prior art systems have been unable to satisfactorily resolve. This area is the inability of prior art electric dry shavers incorporating apertured foils to effectively cut longer hair or whisker shanks or fibers. Longer hair shanks or fibers tend to be less rigid and, consequently, do not enter the apertures of the foil member as the dry shaver is moved over the skin surface. Instead of entering the apertures, the fibers tend to bend and be flexed away from the foil, thereby remaining uncut, leaving an unsatisfactory result.

In order to resolve this deficiency, the shavers incorporating a plurality of rotating, circular shaped cutting blades which cooperate with separate, circular shaped or annular foils or cutting heads have been developed, with each foil or cutting head incorporating radially extending slots formed therein. By incorporating elongated slots in the cutting heads associated with each circular shaped cutting blade, longer hair fibers are capable of being cut efficiently.

Even though the longer hair fiber drawback of foils shavers has been substantially resolved with this rotary shaver construction, shavers incorporating rotary or circular shaped shaving elements are generally incapable of providing shaving results as close as conventional flat foil shavers. Typically, this is due to the thickness of the material which is required to produce circular cutting foils or heads. In addition, another unresolved difficulty which continues to exist with all shavers incorporating rotary or circular shaped cutting elements is the substantial expense incurred in manufacturing the circular shaped, slotted foils or cutting heads.

In general, in manufacturing slotted foils or cutting heads for rotary drive shavers, each cutting element must be stamped in the desired configuration from a metal sheet and then machined or ground in a manner which will provide the desired slotted configuration as well as a sharp cutting edge. Due to the substantial equipment investment, manual labor, and time effort required to produce these slotted foils or cutting heads, each cutting head or slotted foil results in a large financial investment which is incurred in its production. The investment or cost must be incorporated into the overall price for the rotary shaving system.

Consequently, it is a principal object of the present invention to provide an improved rotary drive shaver incorporating circular shaped, slotted foils or cutting heads which are capable of being mass produced at a substantial reduced cost.

Another object or the present mention is to provide an improved rotary drive shaver construction having the characteristic features described above which provides a smooth, comfortable, close shave for both long hair fibers and short hair fibers.

Another object or the present mention is to provide an improved rotary drive shaver construction having the characteristic features described above wherein the slotted foils or cutting heads are manufactured in a substantially final form, ready for assembly in the rotary drive shaver with minimum manual effort being required.

Other and more specific objects will in part be obvious and will in part appear hereinafter.

### SUMMARY OF THE INVENTION

By employing the present invention, all of the difficulties and drawbacks encountered in prior art constructions have been eliminated and a rotary drive shaver is obtained which is capable of being manufactured with the slotted foils or cutting heads being manufactured at a substantially reduced cost, and with precisely desired and controlled configurations. As a result, by employing the present invention, the slotted foils or cutting head employed in the rotary drive shaver provide improved cutting action, achieving a substantially enhanced close and comfortable shave.

In accordance with the present invention, a plurality of circular shaped, slotted foils or cutting heads are simultaneously produced using electroforming production techniques typically employed for producing or manufacturing substantially flat products. In the conventional electroforming process, an image is created having the desired geometry for the product being produced. This image is transferred onto a metal plate, and the metal plate is treated with a photosensitive coating and then exposed to a photo masking process. In the present invention, a plurality of images are formed on the single enlarged metal plate in order to produce a plurality of separate and independent circular shaped slotted foils or cutting heads in a single operation.

Once the plurality of images have been formed on the metal plate and the masking process is completed, current is applied to the metal plate and the metal plate is exposed to a plurality of submersion steps in order to form the desired product in a precisely desired, detailed, and controlled configuration and thickness. Although a substantially flat, two-dimensional product is usually produced, this technique may also be employed to produce a three-dimensional product.

Once the plurality of slotted foils or cutting heads have been produced in a substantially flat configuration by the electroforming process, each of the slotted foils or cutting heads are cut from the metal plate and passed through either a single die or a progressive die to form the slotted foil or cutting head into the desired three-dimensional circular or annular shape required for a rotary shaver.

Due to the desire to produce a slotted foil or cutting head which is extremely thin, in order to attain a close, comfortable shave, each of the fully formed slotted foils or cutting heads is passed through an insert molding operation, wherein a supporting rim or ring is affixed to the outer edge of the slotted foil or cutting head. In this way, the desired rigidity or stiffness is imparted to the resulting product.

In order to complete the entire manufacturing process and attain a final, completed, circular shaped or annular slotted foil or cutting head, a second insert molding step is employed for securing a center hub or support plate to the slotted foil or cutting head. Typically, the center hub or support plate is employed to impart added stiffness to the final product, as well as to provide an outside surface for retaining printed indicia and an inside receiving zone for cooperating alignment with the cutting blades associated therewith.

As is evident from the foregoing, the present invention achieves a fully produced, ready to use, circular shaped or annular slotted foil or cutting head in an extremely efficient, low cost manner. Furthermore, by enabling the slotted foil or cutting head to be produced with a precisely controlled thickness and a precisely controlled slot configuration, an extremely effective, efficient close and comfortable shaving result is achieved.

The invention accordingly comprises the several steps and the relation of one or more such steps with respect to each of the others, and the article produced possessing the features, properties, and relation of elements which are exemplified in the following detailed disclosure, with the scope of the invention and being indicated in the claims.

### THE DRAWINGS

For a fuller understanding of the nature and the object of the invention, reference should be had to the following detailed description taken in connection with the accompanying drawings, in which:

FIG. 1 is a perspective view of a flat, circular shaped, slotted foil or cutting head produced by the electroforming process employed in the present invention;

FIG. 2 is a top plan view of the flat, circular shaped, slotted foil or cutting head of FIG. 1;

FIG. 3 is a substantially enlarged, top view of a portion “A” of the circular shaped, slotted foil or cutting head of FIG. 2;

FIG. 4 is a perspective view of the circular shaped, slotted foil or cutting head of the present invention after passage through a forming die;

FIG. 5 is a top plan view of the circular shaped, slotted foil or cutting head of FIG. 4;

FIG. 6 is a side elevation view, partially in cross-section, of the circular shaped, slotted foil or cutting head of FIG. 5;

FIG. 7 is a perspective view, partially in cross-section, depicting a circular shaped slotted foil or cutting head of the present invention incorporating the outer stiffening rim or ring;

FIG. 8 is a side elevation view of the circular shaped, slotted foil or cutting head of FIG. 7;

FIG. 9 is a perspective view, partially in cross-section, depicting a fully assembled circular shaped slotted foil or cutting head of the present invention;

FIG. 10 is a side elevation view of the circular shaped slotted foil or cutting head of FIG. 9; and

FIG. 11 is a plan view of a sheet of material incorporating a plurality of separate and independent foil members formed thereon.

### DETAILED DESCRIPTION

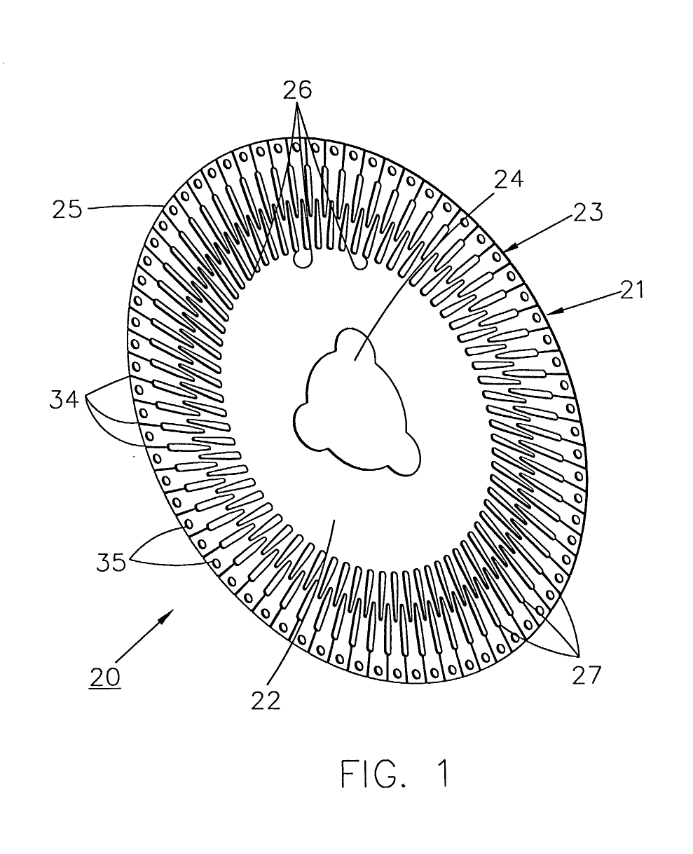

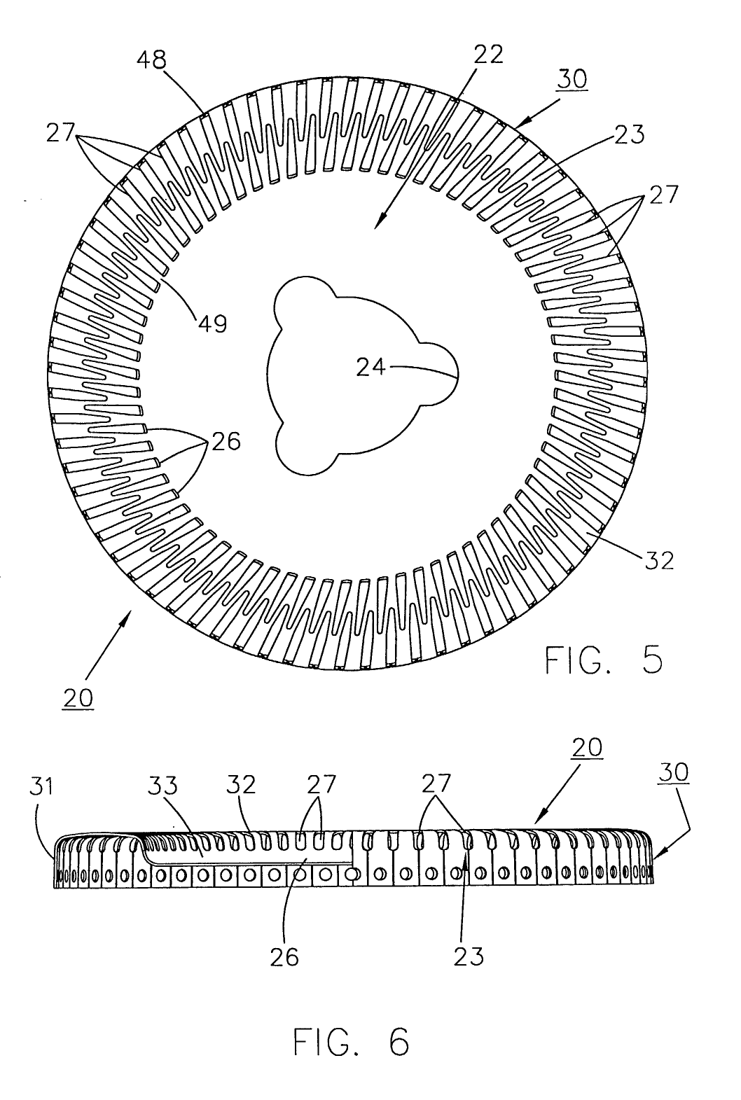

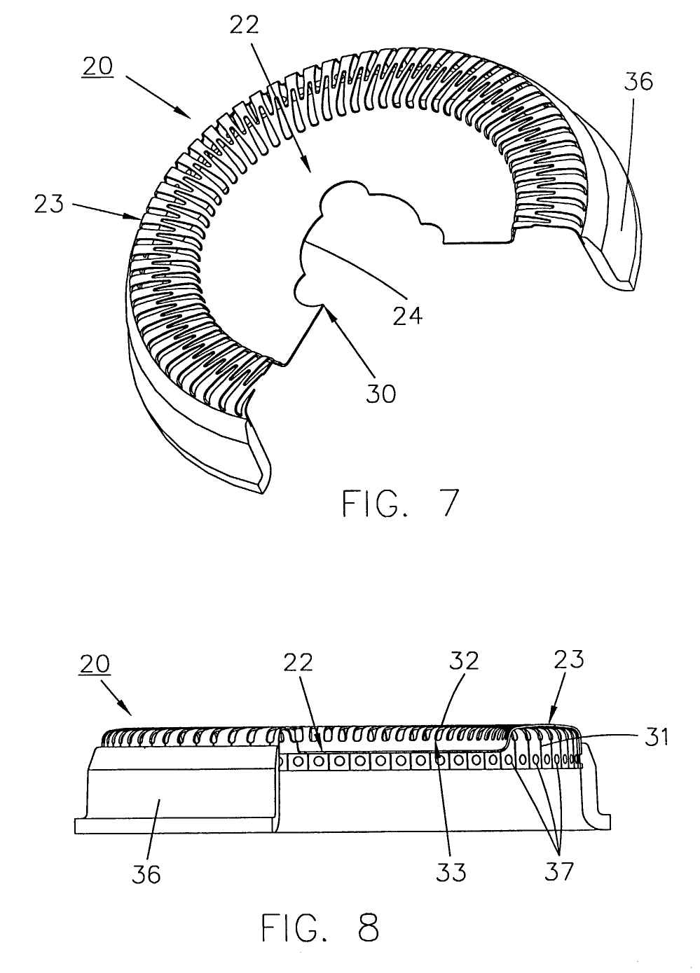

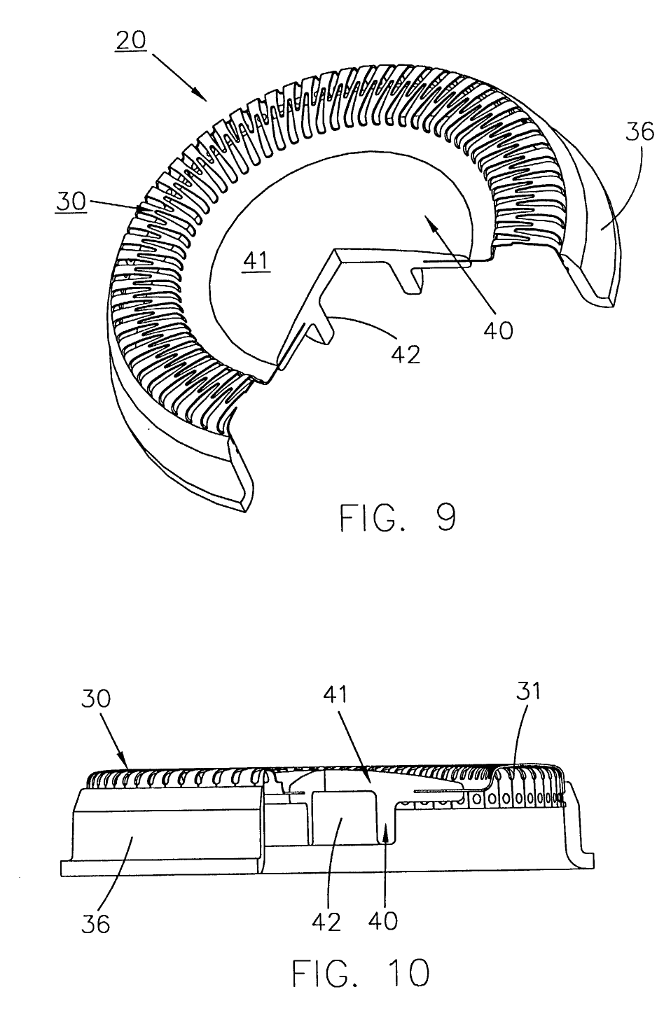

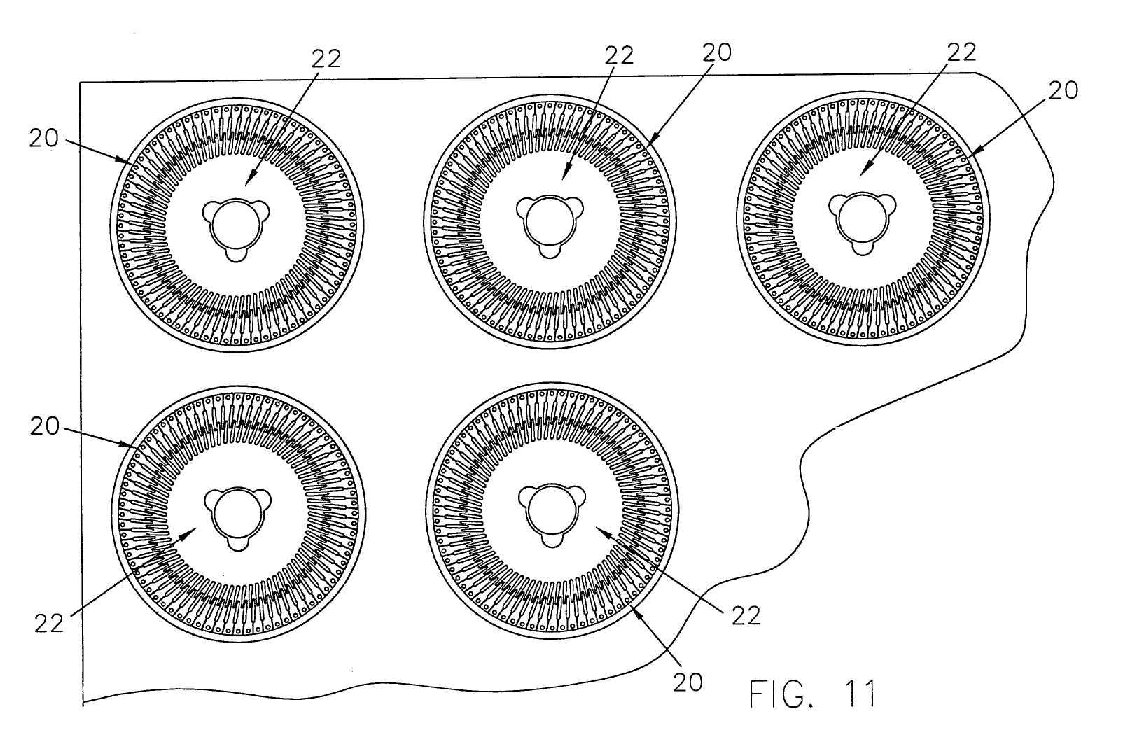

By referring to FIGS. 1-11, along with the following detailed disclosure, the construction, production, and operation of the slotted foil, cutting head, or shear plate 20 of the present invention can best be understood. As detailed herein, the preferred embodiment of slotted foil or cutting head/shear plate 20 of the present invention, as well as its preferred method of manufacture, is fully detailed herein and exemplified in FIGS. 1-11. However, this construction and method of production can be altered without departing from the scope of this invention. Consequently, it is to be understood that the following detailed disclosure is provided for exemplary purposes, and is not intended as a limitation of the scope of the present invention.

In FIGS. 1-3, slotted foil or cutting head/shear plate 20 is depicted as substantially flat plate 21, after production from an electroforming process. In this configuration, which represents its first intermediate configuration of its formation process, flat plate 21 comprises a generally circular shape incorporating two circular shaped, concentric zones or portions, depicted as inside zone 22 and outer zone 23, and an outer terminating edge 25.

As shown, inside zone 22 comprises a substantially flat, smooth surface and a central aperture 24. As depicted, the inside zone 22 extends from central aperture 24 to the boundary with outer zone 23. As is more fully detailed below, central aperture 24 may comprise any desired shape or configuration. However, in the preferred construction, aperture 24 is constructed for receiving and cooperatingly engaging with a central, reinforcing hub.

One principal aspect of the present invention is the construction of outer zone 23 of slotted foil or cutting head/shear plate 20. By employing the present invention, outer zone 23 is constructed in a substantially completed form, without requiring expensive and time-consuming machining operations. In this regard, outer zone 23 is directly formed by an electroforming process to incorporate a plurality of elongated slots 26 and 27 formed throughout zone 23.

By employing the present invention, slots 26 and 27 are constructed with any desired size, shape, and configuration. In addition, slots 27 are capable of being constructed with configurations which were previously impossible, due to the inability of the prior art methods to machine the metal material into such configuration. Examples of such complex slot configurations include sinusoidal shapes, both regular and irregular, as well as other complex shapes incorporating numerous angles and turns. Although the Figures depict generally conventional, longitudinally extending slots 26 and 27, all complex shapes and configurations are within the scope of this invention.

In the preferred construction of outside zone 23 of slotted foil or cutting head/shear plate 20, a plurality of elongated slots 26 and 27 are formed therein. As discussed, although any desired size, shape, and configuration can be employed for slots 26 and 27, one preferred embodiment is depicted in FIGS. 1-3. In this embodiment, elongated slots 26 and 27 are formed in substantially flat plate 21 in a generally aligned, radially extending configuration, forming two partially overlapping circular arrays.

As depicted, radially extending slots 26 are formed in substantially flat plate 21 positioned in juxtaposed, spaced, cooperating relationship with each other, forming a first circular array, with one edge of each elongated slot 26 extending from the boundary with inside zone 22. In addition, radially extending slots 27 are formed in substantially flat plate 21 positioned in juxtaposed, spaced, cooperating relationship with each other, forming a second circular array, with one edge of each elongated slot 27 being formed inwardly of terminating edge 25 of substantially flat plate 21. Furthermore, radially extending slots 26 and 27 are preferably constructed with a portion of each slot of each of the two arrays positioned in a partially overlapping configuration.

In addition, elongated, radially extending slots 26 and 27 are each constructed with radially extending side edges 28 and 29, positioned in juxtaposed, spaced, relationship to each other. This construction is best seen in FIG. 3. By controlling the spaced distance between side edges 28 and 29 of each radially extending slot 26 and 27, the precisely desired control over the cutting action provided by slotted foil or cutting head/shear plate 20 is attained. Although any desired spaced distance can be employed, the preferred embodiment comprises a spacing between side edges 28 and 29 which ranges between about 0.010 and 0.012 inches.

In the preferred embodiment of the present invention, slotted foil or cutting head/shear plate 20 also incorporates a plurality of narrow slits 34 each being formed in outside zone 23 of flat plate 21, extending from terminating edge 25 to the edge of elongated slot 27 which is adjacent terminating edge 25. By incorporating the plurality of narrow slits 34 in substantially flat plate 21, the formation of slotted foil or cutting head/shear plate 20, as detailed below, is capable of being achieved with greater ease.

A further element incorporated into substantially flat plate 21 of slotted foil or cutting head/shear plate 20 are a plurality of small holes or apertures 35 formed in flat plate 21 directly adjacent terminating edge 25. As depicted in the Figures, apertures 35 are preferably formed directly adjacent each other, establishing a substantially circular array of apertures 35 positioned directly adjacent terminating edge 25. In addition, as depicted, elongated narrow slits 34 are positioned, radially extending between apertures 35. As is fully detailed below, apertures 35 are employed in a subsequent formation step of the present invention wherein a stiffening ring is affixed to terminating edge 25.

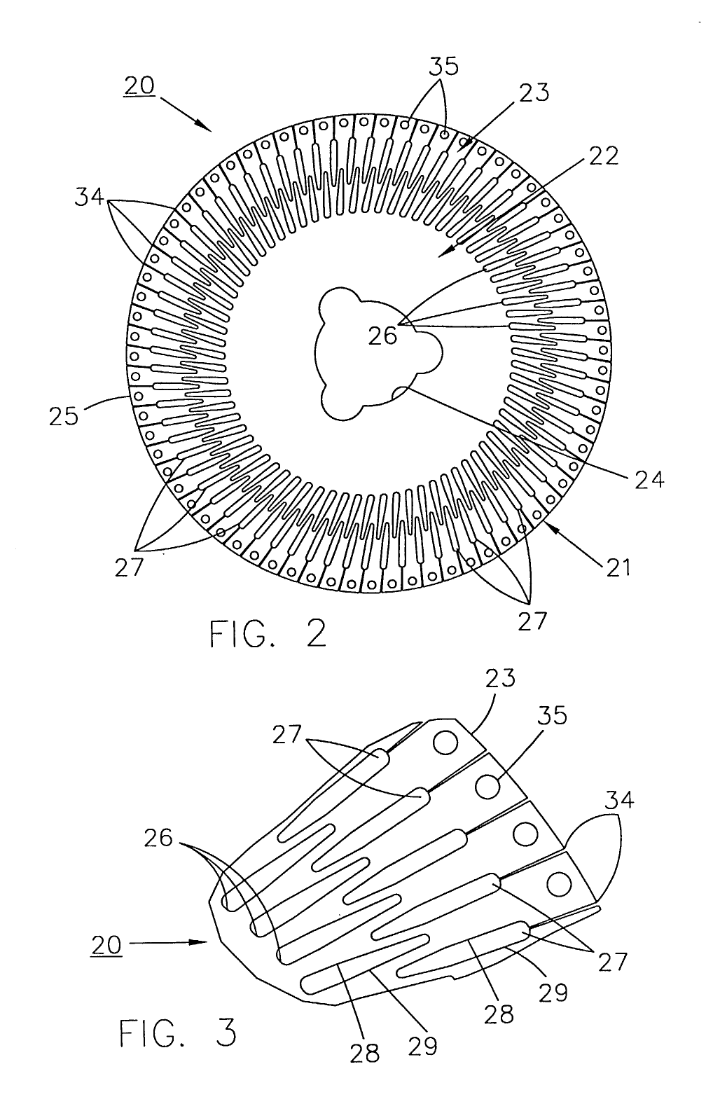

In FIGS. 1 and 2, slotted foil or cutting head/shear plate 20 of the present invention is depicted in its fully configured form as a single component. However, in the preferred construction, as fully detailed below, the process of the present invention enables a plurality of slotted foils or cutting heads/shear plates 20 or flat plates 21 to be simultaneously produced. In this way, substantial cost savings are realized with numerous slotted foils or cutting heads/shear plates 20 or flat plates 21 being produced in a single operation.

In the preferred process, an image is created which represents the desired geometry and configuration for slotted foil or cutting head/shear plate 20. In developing this image, the precisely desired size, shape, and configuration for elongated slots 26 and 27 is developed, along with the configuration for inside zone 22 and aperture 24. Once this final geometry and image has been finalized, the image is transferred onto a metal plate. The metal plate is treated with a photosensitive coating and then exposed to an ultraviolet photo masking process. This process causes the metal sheet to function as a photographic negative, at which point the metal plate is rinsed to expose the desired geometry representing the precisely desired configuration being sought.

In a typical operation, as shown in FIG. 11, the metal plate is produced with a plurality of identical, separate and distinct images formed thereon, with each image representing one slotted foil or cutting head/shear plate 20. Once the construction of the metal plate has been completed, current is passed through the metal plate while the plate is submerged in an electroforming bath.

In the electroforming bath, metal ions are attracted to specific sites of each image formed on the metal plate, causing metal ions to be deposited at the specific sites or locations. By submerging the metal plate in the electroforming bath for a predetermine time period, metal particles accumulate, effectively producing the precisely desired slotted foil or cutting head/shear plate with the precisely desired configuration originally formed on the metal plate.

In addition, by precisely controlling the length of time of the submersion to which the metal plate is subjected, a precisely controlled thickness is achieved for slotted foil or cutting head/shear plate 20. As a result, the electroforming process employed in the present invention achieves all of the attributes desired for an effective, efficient, and close shaving slotted foil or cutting head/shear plate.

By employing the teaching of the present invention, slotted foil or cutting head/shear plate 20 can be formed with any thickness desired. However, it has been found that the preferred thickness of slotted foil or cutting head/shear plate 20 ranges between about 0.0015 and 0.0020 inches.

Once the plurality of slotted foils or cutting heads/shear plates have been produced on the metal foil to the precisely desired specifications, each slotted foil or cutting head/shear plate 20 is removed from the metal foil by die cutting or other appropriate methods. Once removed, slotted foil or cutting head/shear plate 20 is in the configuration of substantially flat plate 21, as depicted in FIGS. 1 and 2.

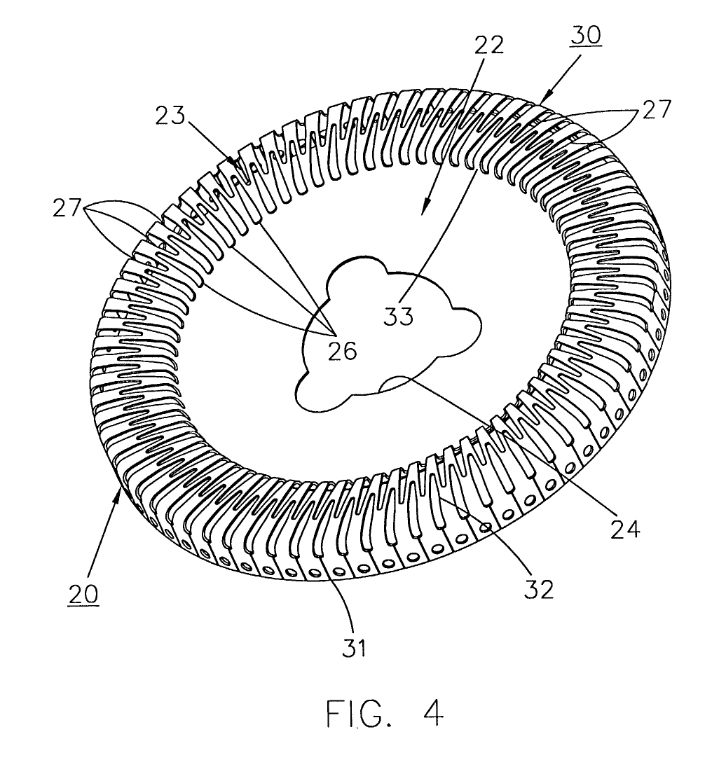

In the next process step of the present invention, substantially flat plate 21 is transferred to a single forming die or a progressive forming die wherein substantially flat plate 21 is formed into fully shaped cutting member 30, depicted in FIGS. 4, 5, and 6. During this forming process, outer zone 23 is bent to form two, co-axial, circular shaped arcs or curved edges 48 and 49, defining distinct sections consisting of a substantially flat top section 32, depending, peripherally surrounding flange section 31, and inside ledge or wall section 33. As depicted, flange section 31 extends substantially perpendicularly from the terminating end of top section 32 at curved edge 48, while ledge or wall section 33 extends substantially perpendicular from top section 32 at curved edge 49. Furthermore, as a result of this construction, slots 27 extend about curved edge 48, defining open zones for easy entry of hair fibers therein along with top section 32 and flange section 31.

Similarly, slot 26 extends about curved edge 49, defining open zones for easy entry of the hair fibers therein along both top section 32 and wall section 33. In this way, entry zone for slots 26 and 27 are provided throughout outside zone 23 of cutting member 30, thereby assuring that the desired cutting action is attained.

As is evident from the foregoing detailed disclosure, as well as best seen in FIG. 6, the die formation step employed in the present invention creates cutting member 30 with a substantially flat, smooth surface forming inside zone 22 and positioned in a first plane, while substantially flat top section 32 is formed in a second plane. In this resulting configuration, the second plane, within which top section 32 is contained, is in juxtaposed, spaced, substantially parallel relationship to the first plane, while also being spaced above the first plane. In this way, the precisely desired overall configuration for cutting member 30 is achieved.

The next step in the construction of slotted foil or cutting head/shear plate 20 of the present invention is the molding of stiffening ring 36 directly to outer, flange section 31 of outer zone 23. Although various alternate methods can be employed, it has been found that the use of insert molding equipment is preferred. Using insert molding equipment, cutting member 30 is positioned in the mold cavity thereof, and the cavity is closed to enable plastic material to be injected into the mold cavity in peripherally surrounding, secure engagement with a portion of flange section 31. Once completed, the plastic is allowed to cool and the resulting product is ejected from the molding equipment.

In order to assure secure, affixed interengagement between plastic ring 36 and flange section 31, flange section 31 is preferably formed with a plurality of holes or apertures 35 formed along the terminating end thereof. In this way, the plastic material is able to pass through apertures 35 and provide secure affixation thereof to flange section 31.

By securely affixing plastic ring 36 directly to flange section 31, added strength and rigidity is imparted to slotted foil or cutting head/shear plate 20. In addition, plastic ring 36 also establishes the final configuration desired for enabling slotted foil or cutting head/shear plate 20 to be easily handled, as well as mounted in position in cooperating relationship with the cutting blades of a rotary shaver.

In accordance with a present invention, the final step in completing the formation of slotted foil or cutting head/shear plate 20 is the affixation of center hub 40 to cutting member 30. This is most easily achieved by employing a second insert molding machine or simultaneously affixing center hub 40 to cutting member 30 along with the affixation of plastic ring 36.

As depicted, center hub 40 is securely affixed to cutting member 30 by employing central aperture 24 of inside zone 22. In this preferred configuration, central hub 40 comprises an enlarged, plate portion 41 which is formed on the top of surface 26, and a receiving cavity 42 formed on the bottom surface thereof, positioned inside of slotted foil or cutting head/shear plate 20. In the preferred construction, receiving cavity 42 is employed for providing co-operative, aligned, interengagement with the cutting blade of the rotary shaver.

In this way, the desired cutting interengagement between the cutting blade and aperture foil or cutting head/shear plate 20 is provided. In addition, plate portion 41 provides added strength and rigidity to slotted foil or cutting head/shear plate 20, while providing an enlarged surface upon which any desired indicia can be displayed.

It will thus be seen that the objects set forth above, among those made apparent from the preceding description, are efficiently obtained and, since certain changes may be made in carrying out the above method and in the article set forth without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having described my invention, what I claim as new and desired to secure by Letters Patent is:

1. A process for producing slotted cutting foil members for rotary dry shavers comprising the steps of:
A. electroforming at least one separate and independent slotted foil member on a single, substantially flat sheet;
B. cutting the independent slotted foil member from the single sheet into a separate component having an outer terminating edge; and
C. passing the separate and independent foil member through a forming die for bending the flat foil member into an annular, three-dimensional shape;
whereby a process is attained for producing cutting foils for rotary dry shavers in a direct manner which virtually eliminates the need for numerous machining operations.

2. The process defined in claim 1, wherein the electroforming step is further defined as comprising the steps of:
a. creating an image having the precisely desired geometry, size, shape, and slotted aperture configuration required for the final product;
b. transferring the image onto a support plate;
c. treating the support plate with a photosensitive coating;
d. masking areas on the support plate were no coating is desired;
e. applying current to the support plate while submerging the support plate in a chemical bath in order to produce a buildup of metal ions in specifically desired locations; and
f. maintaining the plate in the bath until the desired thickness of metal ions has been accumulated on the support plate and the desired configuration attained.

3. The process defined in claim 2, wherein the support plate is produced with a plurality of separate and independent images formed thereon, with each image defining a single slotted, foil-forming member.

4. The process defined in claim 3, wherein each of the separate and independent images incorporates a plurality of separate and independent zones in which no material is built up, said zones forming the open slots of the cutting foil.

5. The process defined in claim 4, wherein each of said slots comprises any desired size, shape, length, and configuration.

6. The process defined in claim 5, wherein each of said slots are defined by side edges formed in juxtaposed, spaced, cooperating relationship with each other, with said side edges being spaced apart a distance ranging between about 0.010 and 0.012 inches.

7. The process defined in claim 4, wherein each foil member comprises a narrow slit extending from the outer terminating edge of the foil member to the leading edge of the slot formed therein directly adjacent the terminating edge of the foil member, thereby enabling the outer portion of the foil member to be formed into the desired configuration.

8. The process defined in claim 7, wherein each foil member is further defined as comprising a plurality of apertures formed therein directly adjacent the terminating edge thereof, with each of said apertures being aligned with each other to form a generally circular configuration.

9. The process defined in claim 8, comprising the additional step of:
D. passing the each foil member through insert molding equipment after the foil member has been formed into its annular, three-dimensional configuration for producing an outer, peripherally surrounding ring of plastic material extending from the terminating edge of the slotted cutting foil.

10. The process defined in claim 9, wherein said outer, peripherally surrounding ring of plastic material is securely affixed to the terminating edge of the cutting foil by passage of the plastic material through the apertures formed therein.

11. The process defined in claim 9, and further comprising the additional step of:
E. passing each foil member through a second insert molding operation wherein a center hub is affixed to the central area of the foil member for imparting greater strength and rigidity thereto.

12. The process defined in claim 11, wherein the slotted cutting foil member is further defined as comprising an aperture formed in the center thereof and the hub is affixed to the cutting foil member through said central aperture.

13. The process defined in claim 2, wherein the thickness of each slotted cutting foil member ranges between about 0.0015 and 0.0020 inches.

14. The process defined in claim 1, wherein the slotted cutting foil member produced is further defined as comprising:
a. a substantially smooth, flat, circular shaped, central portion incorporating an enlarged aperture formed therein, and
b. an outer portion peripherally surrounding the central portion, extending from a common boundary with said central portion, and incorporating a plurality of elongated slots formed therein, each of said slots extending radially outwardly from the common boundary with the central portion towards the outer terminating edge of the foil member.

15. The process defined in claim 14, wherein the slotted cutting foil member is further defined as comprising radially extending, elongated slots terminating inwardly of the outer terminating edge of the foil member.

16. The process defined in claim 15, wherein the radially extending, elongated slots are further defined as being positioned in a substantially adjacent, aligned relationship with each other, forming a substantially continuous circular shaped display.

17. The process defined in claim 16, wherein the radially extending, elongated slots are further defined as forming two separate and independent circular shaped displays comprising an inwardly positioned display and outwardly positioned display, with a portion of each slot in the inwardly positioned display overlapping at least a portion of each adjacent slot in the outwardly positioned display.

18. The process defined in claim 17, wherein the forming die imparts a first circular shaped bend to the slotted cutting foil member along the length of the slots formed in the outwardly positioned display, with said bend creating a substantially flat, top portion and a first dependent wall portion extending from the flat top portion at substantially right angles thereto.

19. The process defined in claim 18, wherein the forming die imparts a second circular shape bend to the slotted cutting foil member along the length of the slots formed in the inwardly positioned display, with said bend creating a second dependent wall portion extending from the flat top portion to the central portion.

20. The process defined in claim 19, wherein each of said slots are positioned on the substantially flat top portion and one of said wall portions.

21. A shear plate or cutting head for use in rotary dry shavers, said shear plate/cutting head comprising a generally circular shaped metal cutting foil portion and an outer peripherally surrounding plastic ring portion affixed to the outer edge of the metal foil for imparting rigidity thereto, said metal foil portion comprising a plurality of slots formed therein and being formed by electroforming and passage through forming dies to achieve the desired shape.

22. The shear plate/cutting head defined in claim 21, wherein said plastic ring is affixed to the metal foil portion by insert molding.

23. The shear plate/cutting head defined in claim 22, wherein the cutting foil portion comprises a central aperture formed therein and an enlarged plastic hub is affixed to the foil portion by mounted engagement in said aperture.
